(19) United States
(12) Patent Application Publication
(10) Pub. No.: US 2008/0109902 A1
(43) Pub. Date: May 8, 2008

(54) Methods and apparatus for overriding denunciations of unwanted traffic in one or more packet networks

(76) Inventors: Eric H. Grosse, Berkeley Heights, NJ (US); Clifford E. Martin, Martinsville, NJ (US)

Correspondence Address: Ryan, Mason & Lewis, LLP, Suite 205, 1300 Post Road, Fairfield, CT, 06824, US

(21) Appl. No.: 11/592,725

(22) Filed: Nov. 3, 2006

(51) Int. Cl. G06F 11/00

(52) U.S. Cl. 726/22

(57) ABSTRACT

Methods and apparatus are provided for selectively overriding the blocking of traffic due to automated detection algorithms. A target victim can protect against unwanted traffic by maintaining a central filter identifying a source address of at least one source computing device whose transmission of packets to the target victim should be limited; maintaining an override filter listing at least one regular expression identifying one or more source computing devices whose transmission of packets to the target victim should be transmitted to the target victim; converting the source address to an address in a Domain Name Service format if the central filter indicates that the received at least one packet is received from the at least one source computing device; and transmitting the at least one packet to the target victim if the Domain Name Service format satisfies a regular expression appearing in the override filter.

### CROSS-REFERENCE TO RELATED APPLICATION

The present application is related to U.S. patent application Ser. No. 11/197,842, entitled “Method and Apparatus for Defending Against Denial of Service Attacks in IP Networks by Target Victim Self-Identification and Control,” and U.S. patent application Ser. No. 11/197,841, entitled “Method and Apparatus for Defending Against Denial of Service Attacks in IP Networks Based on Specified Source/Destination IP Address Pairs,” each filed Aug. 5, 2005, assigned to the assignee of the present invention and incorporated by reference herein.

### FIELD OF THE INVENTION

The present invention relates to computer security techniques for packet-based communications networks, and more particularly, to methods and apparatus for detecting and denouncing unwanted traffic, such as Denial of Service attacks and other malicious attacks, in such packet-based networks.

### BACKGROUND OF THE INVENTION

Denial-of-service (DoS) attacks attempt to make computer resources unavailable to their intended users. For example, a DoS attack against a web server often causes the hosted web pages to be unavailable. DoS attacks can cause significant service disruptions when limited resources need to be allocated to the attackers instead of to legitimate users. The attacking machines typically inflict damage by sending a large number of Internet Protocol (IP) packets across the Internet, directed to the target victim of the attack. For example, a DoS attack can comprise attempts to “flood” a network, thereby preventing legitimate network traffic, or to disrupt a server by sending more requests than the server can handle, thereby preventing access to one or more services.

A number of techniques have been proposed or suggested for defending against such Denial of Service attacks. For example, U.S. patent application Ser. No. 11/197,842, entitled “Method and Apparatus for Defending Against Denial of Service Attacks in IP Networks by Target Victim Self-Identification and Control,” and U.S. patent application Ser. No. 11/197,841, entitled “Method and Apparatus for Defending Against Denial of Service Attacks in IP Networks Based on Specified Source/Destination IP Address Pairs,” disclose techniques for detecting and denouncing DoS attacks.

Systems that defend against such Denial of Service attacks typically operate in one of two modes. When the zone is in a “default-drop” mode, the default behavior is to filter all traffic destined for the zone except traffic explicitly listed on the default-drop. Generally, in a default-drop mode, the filter will automatically drop all traffic unless explicit authorized (for example, matching a predefined allow filter). When the zone is in default-allow mode, on the other hand, all traffic to the subscriber is passed by the filter, except that traffic that explicitly matches a predefined drop filter.

One of the operational problems with blocking clients on the basis of automated detection algorithms is that they may block traffic that is valued or otherwise should be exempt from the blocking. For example, an enterprise may not want to block any traffic from certain customers or certain third party services, such as indexing robots, that are valued and should be exempt from the blocking. It has been found, however, that maintaining a list of the IP addresses of all such clients is infeasible because the lists may change based on events that are unknowable at the detector, such as network provider changes. A need therefore exists for methods and apparatus for selectively overriding the blocking of traffic due to automated detection algorithms.

### SUMMARY OF THE INVENTION

Generally, methods and apparatus are provided for selectively overriding the blocking of traffic due to automated detection algorithms. According to one aspect of the invention, a target victim can protect against unwanted traffic, such as malicious attack or a Denial of Service attack, by maintaining a central filter identifying a source address of at least one source computing device whose transmission of packets to the target victim is to be one or more of limited, dropped or allowed; maintaining an override filter listing at least one regular expression identifying one or more source computing devices whose transmission of packets to the target victim should be transmitted to the target victim regardless of an entry in the central filter; converting the source address to an address in a Domain Name Service format if the central filter indicates that the received at least one packet is received from the at least one source computing device; and transmitting the at least one packet to the target victim if the Domain Name Service format satisfies a regular expression appearing in the override filter.

The source address can be converted to an address in a Domain Name Service format, for example, by performing a reverse DNS lookup. The regular expression may be, for example, a Domain Name Service format mask containing one or more wildcard fields.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention may operate;

FIG. 2 is a schematic block diagram of the central filter system of FIG. 1;

FIG. 3 is a sample table from the denial of service filter rule base of FIG. 2;

FIG. 4 is a sample table from the filter override database of FIG. 2; and

FIG. 5 is a flow chart describing an exemplary implementation of a denial of service filtering process incorporating features of the present invention.

### DETAILED DESCRIPTION

The present invention provides methods and apparatus for overriding the denunciation of malicious attacks, such as Denial of Service attacks, in one or more packet networks. Generally, at the time the detector is about to do a denunciation, a reverse DNS lookup is performed on the source address to see if the name matches certain pre-configured regular expressions, such as proxy*.isp.com or *.searchenginebot.com. In this manner, a DNS lookup is not required for each address of the log the detector is analyzing.

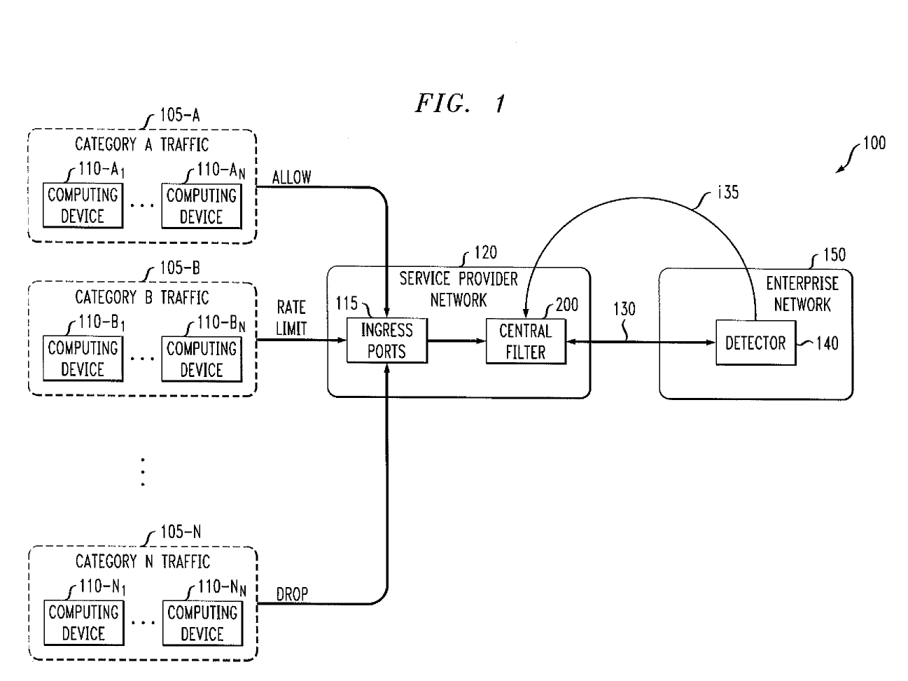

FIG. 1 illustrates a network environment 100 in which the present invention may operate. As shown in FIG. 1, an enterprise network 150 protects itself against malicious attacks using a detector 140. The enterprise network 150 allows enterprise users to access the Internet or another network by means of a service provider network 120. The service provider network 120 provides service to users of the enterprise network 150, and receives packets from various sources by means of ingress ports 115 and transmits them to the indicated destination in the enterprise network 150.

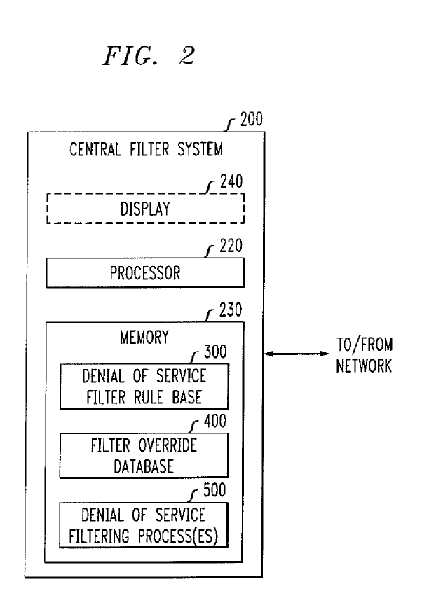

In one exemplary embodiment, the detector 140 cooperates with a central filter 200, discussed further below in conjunction with FIG. 2, to protect itself against malicious attacks. Generally, as discussed further below, the detector 140 will detect a malicious attack, such as a Denial of Service attack, against the enterprise network 150 and will notify the central filter 200 maintained by the service provider.

The central filter 200 serves to limit the traffic that reaches the enterprise network 150 by means of the service provider network 120. The detector 140 typically sits behind the firewall in the enterprise network 150 and the detector 140 typically sends denunciation messages to the central filter 200 of the ISP. The detector 140 and central filter 200 may be implemented based on U.S. patent application Ser. No. 11/197,842, entitled “Method and Apparatus for Defending Against Denial of Service Attacks in IP Networks by Target Victim Self-Identification and Control,” and U.S. patent application Ser. No. 11/197,841, entitled “Method and Apparatus for Defending Against Denial of Service Attacks in IP Networks Based on Specified Source/Destination IP Address Pairs,” as modified herein to provide the features and functions of the present invention.

The detector 140, upon determining that a Denial of Service attack is being perpetrated on the enterprise network 150, transmits one or more source/destination IP address pairs to the central filter 200, which causes the service provider network 120 to limit (e.g., block or rate limit) the transmission of IP packets whose source IP address and destination IP address match those of any of the transmitted source/destination IP address pairs, thereby limiting (or eliminating) the Denial of Service attack from one or more source devices 110 to the attack victim within the enterprise network 150. The detector 140 optionally transmits the source/destination IP address pairs with use of a redundant connection 135 or the primary connection 130.

The disclosed system thus allows the victim of a Denial of Service attack to “push back” by denouncing attackers to its service provider, which will, in response, update a table of source/destination IP address pairs that are to be blocked. More specifically, upon recognizing that an attack is taking place, the victim (enterprise network 150) will identify one or more pairs of source and destination IP addresses that are specified in packets deemed to be a part of the attack, and communicate those IP address pairs to the service provider for blocking by the central filter 200.

As shown in FIG. 1, packets destined to the subscriber (enterprise network 150) is classified into classes, generally corresponding to “good” and “bad” traffic. For example, good traffic from Category A 105-A is delivered (allowed) and bad traffic from Category B 105-B and Category N 105-N is rate-limited or dropped, respectively. Source computing devices 110 that send traffic to a destination address associated with the enterprise network 150 are classified into one of the N exemplary categories. Denunciations shift the boundary between good and bad traffic.

Note that, in accordance with certain illustrative embodiments, the attacker (i.e., the identified source IP address or addresses) need not be cut off completely from the network, but rather may be prohibited only from sending packets to the victim (i.e., the identified destination IP address or addresses). This may be advantageous, particular in the case where the identified source IP address or addresses represent a legitimate user which has been taken over (e.g., a zombie) for the given attack against the victim. Thus, the owner of the machine that was taken over may continue to use the system for legitimate purposes, while the attack being perpetrated on the victim (possibly unbeknownst to the legitimate user) is nonetheless advantageously thwarted. Moreover, note that the technique in accordance with such illustrative embodiments also advantageously provides protection from overly zealous identification of attackers by a given victim. Since, in accordance with the principles of the present invention, the identification of an attack is left to the discretion of the apparent victim, it is clearly advantageous that only traffic to the given victim is being cut off or restricted.

A malicious attack may be recognized by the victim by one or more algorithms of varying degrees of simplicity or sophistication, which are outside the scope of the present invention, but many of which will be obvious to those skilled in the art. For example, in accordance with one illustrative embodiment of the invention, application logs may be examined and an attack may be identified based solely on the presence of very high traffic levels (e.g., high packet rates) from either a single identified source or a plurality of identified sources. It is noted that this is one conventional method of identifying the presence of a Denial of Service attack and will be familiar to those of ordinary skill in the art.

In other implementations, however, application based analysis of packet contents may be performed to identify packets or sequences of packets having a suspicious nature, such as, for example, recognizing that there have been frequent database searches for non-existent database elements; recognizing that there have been multiple requests apparently from a human being which occur at a higher rate than a person could initiate them; identifying syntactically invalid requests; and identifying suspicious amounts of traffic at particularly sensitive times in the operation of a normally occurring activity. An example of the latter class of suspicious packets might be identified, for example, if a stock trading web site notices particularly disruptive traffic at a sensitive time during an imminent stock transaction. In further variations, a number of different indicia of a possible attack, which may include, for example, one or more of the above described situations, may be advantageously combined in a more sophisticated analysis to identify the presence of an attack.

FIG. 2 is a schematic block diagram of the central filter system 200 of FIG. 1 that can implement the processes of the present invention. As shown in FIG. 2, memory 230 configures the processor 220 to implement the denial of service filtering methods, steps, and functions disclosed herein. The memory 230 could be distributed or local and the processor 220 could be distributed or singular. The memory 230 could be implemented as an electrical, magnetic or optical memory, or any combination of these or other types of storage devices. It should be noted that each distributed processor that makes up processor 220 generally contains its own addressable memory space. It should also be noted that some or all of computer system 200 can be incorporated into an application-specific or general-use integrated circuit.

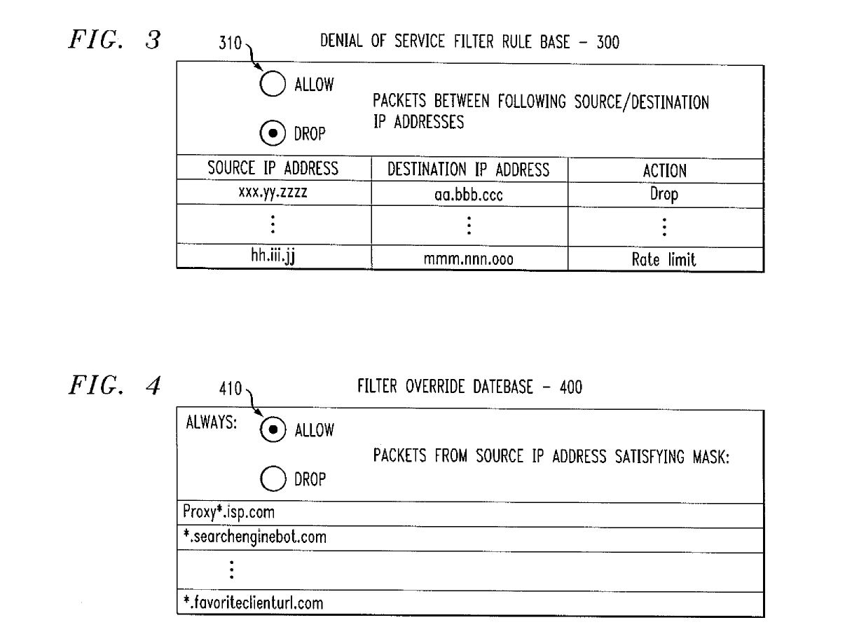

As shown in FIG. 2, the exemplary memory 230 includes a denial of service filter rule base 300, a filter override database 400, and one or more denial of service filtering processes 500, each discussed further below in conjunction with FIGS. 3 through 5, respectively. Generally, the denial of service filter rule base 300 is a conventional filter base containing source/destination address pairs associated with traffic that should be limited or allowed by the central filter 200. The filter override database 400 contains one or more pre-configured regular expressions, such as proxy*.isp.com or *.searchenginebot.com, that allow one or more denunciations in the denial of service filter rule base 300 to be overridden. The denial of service filtering process 500 is an exemplary method for defending against Denial of Service or other attacks in accordance with the denunciation override feature of the present invention.

The central filter 200 may be implemented as a stand-alone box included in the service provider network 120, or, alternatively, as a line card incorporated into otherwise conventional network elements that are already present in the network 120. Moreover, in accordance with certain illustrative embodiments, the central filter 200 may be advantageously deployed by the carrier within the network 120 at a location relatively close to the attack origins, or it may be initially placed to advantageously defend premium customers from attack.

FIG. 3 is a sample table from the denial of service filter rule base 300 of FIG. 2. As indicated above, the denial of service filter rule base 300 is typically implemented as a conventional filter base containing source/destination address pairs associated with traffic that should be limited or allowed by the central filter 200.

As indicated above, systems that defend against such Denial of Service attacks typically operate in one of two modes. In a “default-drop” mode, the default behavior filters all traffic destined for the zone except traffic explicitly listed in the denial of service filter rule base 300. In a default-allow mode, on the other hand, all traffic to the subscriber is passed by the filter 200, except that traffic that explicitly matches a predefined drop filter in the denial of service filter rule base 300. Thus, as shown in FIG. 3, the exemplary denial of service filter rule base 300 includes an optional button selection 310 that allows the user to specify whether the default mode is to drop or allow traffic. In the exemplary implementation shown in FIG. 3, the denial of service filter rule base 300 is configured for an exemplary “default allow” mode, such that traffic to the subscriber is passed by the filter 200, except that traffic that explicitly matches a predefined drop filter in the denial of service filter rule base 300.

In the exemplary implementation shown in FIG. 3, the denial of service filter rule base 300 is comprised of source/destination address pairs, and an optional indicated action that should be performed for all traffic between each listed source/destination address pair.

It is noted that the operation of the filtering mechanism of the central filter 200 may be similar to that of a conventional firewall, except that it operates based on a potentially large number (e.g., millions) of very simple rules. In particular, the rules may be expressed in the form “if the source IP address of a given packet is a.b.c.d and the destination IP address of the packet is w.x.y.z, then block (i.e., drop) the packet.”

Rather than prohibiting the transmission of packets with a given source and destination IP address, the central filter 200 may de-prioritize such packets. That is, the filtering mechanism may either assign such packets a low routing priority or enforce a packet rate limit on such packets. In either case, packets with the given source and destination IP addresses will be unable to have a significant effect on traffic and thus will no longer result in a successful Denial of Service attack on the victim.

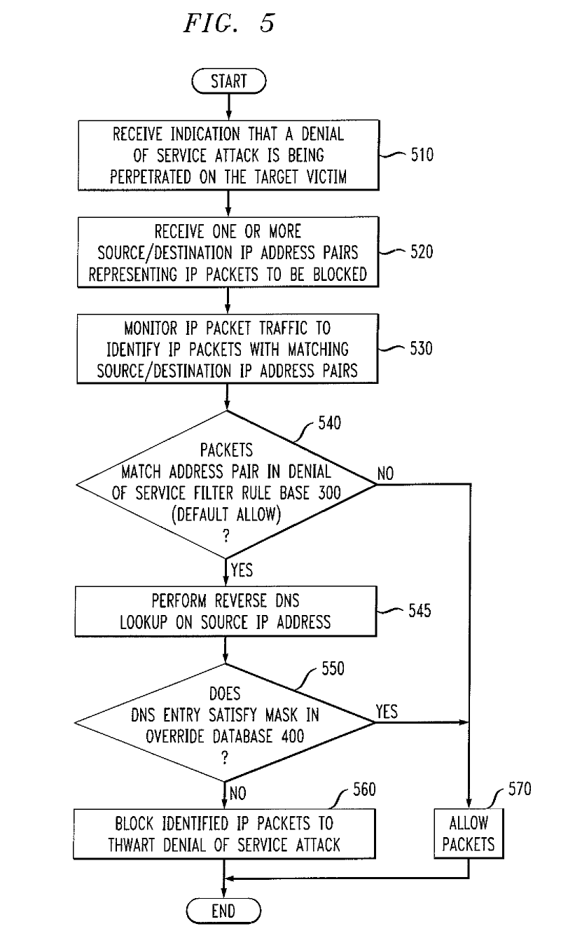

FIG. 4 is a sample table from the filter override database 400 of FIG. 2. The filter override database 400 contains one or more pre-configured regular expressions, such as proxy*.isp.com or *.searchenginebot.com, that allow one or more denunciations in the denial of service filter rule base 300 to be overridden. In the exemplary implementation shown in FIG. 4, the filter override database 400 is configured for an exemplary “default allow” mode, such that exemplary drop filters listed in the denial of service filter rule base 300 can be overridden by one or more masks listed in the filter override database 400. The manner in which the regular expressions shown in FIG. 4 are used is discussed further below in conjunction with FIG. 4.

FIG. 5 is a flow chart describing an exemplary implementation of a denial of service filtering process incorporating features of the present invention. It is noted that the exemplary denial of service filtering process 500 is implemented for a “default-allow” mode. An implementation for a “default drop” mode would be readily apparent to a person of ordinary skill in the art. Generally, the denial of service filtering process 500 is an exemplary method for defending against Denial of Service or other attacks and implements the denunciation override feature of the present invention. The illustrative denial of service filtering process 500 is performed at the central filter 200 and begins during step 510 by receiving an indication from the detector 140 that a Denial of Service attack is being perpetrated on a given target victim in the enterprise network 150.

Thereafter, during step 520, the network carrier receives one or more source/destination IP address pairs from the detector 140 representative of IP packets that should be blocked in order to thwart the Denial of Service attack. Illustratively, the source IP addresses are those of the attacking (e.g., “zombie”) computing devices 110 and the destination IP addresses are those associated with the target victim itself.

The network carrier then monitors the IP packet traffic during step 530 to identify IP packets whose source and destination IP addresses match one of the received source/destination IP address pairs. A test is performed during step 540 to determine if one or more packets match an address pair in the denial of service filter rule base 300.

If it is determined during step 540 that one or more packets match an address pair in the denial of service filter rule base 300, then a reverse DNS lookup is performed during step 545 on the source IP address. The reverse DNS lookup will return a full address, typically in a known Domain Name Service (DNS) format, associated with the source IP address. As used herein, a Domain Name Service format shall include any domain name representation of an IP or other packet address.

A further test is performed during step 550 to determine if the DNS entry satisfies a mask in the override database 400. If it is determined during step 550 that the DNS entry does satisfy a mask in the override database 400, then the packets should not be dropped or limited (despite the appearance in the denial of service filter rule base 300) and program control proceeds to step 570, discussed below. If, however, it is determined during step 550 that the DNS entry does not satisfy a mask in the override database 400, then the central filter 200 of the network carrier blocks the identified IP packets, thereby thwarting the Denial of Service attack on the target victim.

If it was determined during step 540 that one or more packets do not match an address pair in the denial of service filter rule base 300, or if it was determined during step 550 that the DNS entry does satisfy a mask in the override database 400, then the packets are allowed to be transmitted to the enterprise network 150.

In a “default drop” implementation of the denial of service filtering process 500, the central filter 200 would pass packets from any source device listed in the filter override database 400, even if the listed source device does not explicitly appear in the denial of service filter rule base 300.

It is further noted that although illustrated as being performed by the central filter 200 in the illustrative embodiment, the denunciation override feature of the present invention can likewise be performed by a detector 140, as would be apparent to a person of ordinary skill in the art.

The present invention may work in conjunction with one or more supplementary tools. For example, such tools might include Internet server plug-ins for recognition of leveraged Denial of Service attacks, links to various IDS systems (Intrusion Detection Systems), databases for network diagnosis (see discussion above), and methods for providing guidance for placement of Zapper functionality within a given carrier's infrastructure. Illustrative embodiments of the present invention which provide various ones of these supplementary tools will be obvious to those skilled in the art in light of the disclosure herein.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for defending against unwanted traffic received by a target victim, the target victim having one or more destination addresses, the method comprising the steps of:
maintaining a central filter identifying a source address of at least one source computing device whose transmission of packets to said target victim is to be one or more of limited, dropped or allowed;
maintaining an override filter listing at least one regular expression identifying one or more source computing devices whose transmission of packets to said target victim should be transmitted to said target victim regardless of an entry in said central filter;
converting said source address to an address in a Domain Name Service format if said central filter indicates that at least one received packet is received from said at least one source computing device; and
transmitting said at least one received packet to said target victim if said Domain Name Service format satisfies a regular expression appearing in said override filter.

2. The method of claim 1, wherein said source address in said central filter is received from a detector associated with said target victim indicating that unwanted traffic is being received.

3. The method of claim 1, wherein said source address in said central filter is received from said target victim during a configuration of said central filter.

4. The method of claim 1, wherein said converting step comprises the step of performing a reverse DNS lookup.

5. The method of claim 1, wherein said source address comprises an IP address.

6. The method of claim 1, wherein said central filter comprises one or more source/destination address pairs.

7. The method of claim 1, wherein said regular expression is a Domain Name Service mask containing one or more wildcard fields.

8. The method of claim 1, further comprising the step of monitoring packet traffic to identify packets having a source address that matches a source address in said central filter.

9. The method of claim 1, wherein said unwanted traffic comprises a malicious attack or a Denial of Service attack.

10. An apparatus for defending against unwanted traffic received by a target victim, the target victim having one or more destination addresses, the apparatus comprising:
a memory; and
at least one processor, coupled to the memory, operative to:
maintain a central filter identifying a source address of at least one source computing device whose transmission of packets to said target victim is to be one or more of limited, dropped or allowed;
maintain an override filter listing at least one regular expression identifying one or more source computing devices whose transmission of packets to said target victim should be transmitted to said target victim regardless of an entry in said central filter;
convert said source address to an address in a Domain Name Service format if said central filter indicates that at least one received packet is received from said at least one source computing device; and
transmit said at least one received packet to said target victim if said Domain Name Service format satisfies a regular expression appearing in said override filter.

11. The apparatus of claim 10, wherein said source address in said central filter is received from a detector associated with said target victim indicating that unwanted traffic is being received.

12. The apparatus of claim 10, wherein said source address in said central filter is received from said target victim during a configuration of said central filter.

13. The apparatus of claim 10, wherein said source address is converted to an address in a Domain Name Service format by performing a reverse DNS lookup.

14. The apparatus of claim 10, wherein said source address comprises an IP address.

15. The apparatus of claim 10, wherein said central filter comprises one or more source/destination address pairs.

16. The apparatus of claim 10, wherein said regular expression is a Domain Name Service format mask containing one or more wildcard fields.

17. The apparatus of claim 10, wherein said processor is further configured to monitor packet traffic to identify packets having a source address that matches a source address in said central filter.

18. The apparatus of claim 10, wherein said unwanted traffic comprises a malicious attack or a Denial of Service attack.

19. An article of manufacture for defending against unwanted traffic received by a target victim, the target victim having one or more destination addresses, comprising a machine readable medium containing one or more programs which when executed implement the steps of:
maintaining a central filter identifying a source address of at least one source computing device whose transmission of packets to said target victim is to be one or more of limited, dropped or allowed;
maintaining an override filter listing at least one regular expression identifying one or more source computing devices whose transmission of packets to said target victim should be transmitted to said target victim regardless of an entry in said central filter;
converting said source address to an address in a Domain Name Service format if said central filter indicates that at least one received packet is received from said at least one source computing device; and
transmitting said at least one received packet to said target victim if said Domain Name Service format satisfies a regular expression appearing in said override filter.

20. The article of manufacture of claim 19, wherein said regular expression is a Domain Name Service mask containing one or more wildcard fields.
